(19) United States
(12) Patent Application Publication
(10) Pub. No.: US 2007/0035634 A1
(43) Pub. Date: Feb. 15, 2007

(54) System and method for reduction of chroma aliasing and noise in a color-matrixed sensor

(76) Inventor: Albert D. Edgar, Austin, TX (US)

Correspondence Address: ANDERSON & JANSSON, L.L.P., 9501 N. CAPITAL OF TX HWY. #202, AUSTIN, TX, 78759, US

(21) Appl. No.: 11/203,564

(22) Filed: Aug. 12, 2005

(51) Int. Cl. H04N 5/228

(52) U.S. Cl. 348/222.1

(57) ABSTRACT

Provided is a system and method for processing images. A method is provided for reducing noise and/or aliasing from an image sampled in a plurality of spatial phases, including, but not limited to selecting at least two of the plurality of spatial phases; and performing a difference calculation of the at least two spatial phases to determine a measure of one or more noise and/or aliasing components

### TECHNICAL FIELD

The present application relates generally to the field of image processing.

### BACKGROUND

Digital cameras are more and more popular as the technology supporting them improves. One technology area that is in need of improvement is the effect of noise and aliasing. Depending on the type and expense of a digital camera, the aliasing can be more or less present. Aliasing typically manifests as Moiré patterns on images with high frequency repetitive patterns, such as window screens and fabrics. More expensive cameras reduce aliasing by anti-aliasing (low pass) filters, which are expensive and unavoidably reduce resolution by introducing “blurring” of signal. Other methods for reducing aliasing include providing a digital camera with pixels smaller than 4 μm, which causes other problems such as lens diffraction, which prevents small aperture images and generally any aperture lower than f/5.6.

Currently, digital cameras typically employ a color filter array, which includes a filter grid covering a sensor array so that each pixel is sensitive to a single primary color, either red (R), green (G), or blue (B). Typically, a Bayer pattern includes a pattern with two green pixels for each red and blue pixel. Green typically covers 50% of a Bayer array because the human eye is most sensitive to green.

A Bayer array is known to suffer from artifact, resolution, noise and aliasing issues. Many of the issues with a Bayer array are due to Moiré fringing caused by the interpolation process/demosaic process used to determine data for the two missing colors at each pixel location. The red and blue pixels are spaced twice as far apart as the green pixels. Thus, the resolution for the red and blue pixels is roughly half that of green. Many reconstruction algorithms have been developed to interpolate/demosaic image data, but interpolation/demosaicing can result in file size growth and can require a time consuming algorithm.

What is needed is a solution for aliasing and artifact removal for digital cameras that lack anti-aliasing filters and does not require computationally intense algorithms.

### SUMMARY

A method is provided for reducing noise from an image sampled using an array with a plurality of spatial sampling phases, the image including a plurality of signal components and a plurality of noise components. The method includes but is not limited to selecting at least two of the plurality of spatial sampling phases; estimating a measure of at least one of the plurality of noise components via performing a difference calculation of the image at the at least two spatial sampling phases; and estimating at least one of the signal components via removing the measure of at least one of the plurality of noise components.

One embodiment is directed to a computer program product that is provided for a computer readable medium configured to perform one or more acts for removing noise from an image created from an image sensor array, the one or more acts include but are not limited to selecting at least two of the plurality of spatial sampling frequencies; estimating a measure of at least one of the plurality of noise components via performing a difference calculation of the image at the at least two spatial sampling frequencies; and estimating at least one of the signal components via removing the measure of at least one of the plurality of noise components.

One embodiment is directed to a computer program product comprising a computer readable medium configured to perform one or more acts for attenuating noise from an image created from an image sensor array, the one or more acts including, but not limited to determining a first color difference between at least two representations of same-based color components of an image created by the image sensor array; determining a second color difference between at least two representations of color components of the image, the at least two color components independent of the at least two same-based color components; comparing a first magnitude of the first difference with a second magnitude of the second color difference; and determining that the at least two same-based color components represent a noise component based on the comparing the first magnitude and the second magnitudes.

One embodiment is directed to a computer system including, but not limited to a processor; a memory coupled to the processor; and an image processing module coupled to the memory, the image processing module configured to attenuate noise from an image sampled in a plurality of spatial sampling frequencies, the image including a plurality of signal components and a plurality of noise components, module including a selection component configured to select at least two of the plurality of spatial sampling frequencies; a measurement component configured to estimate a measure of at least one of the plurality of noise components via performing a difference calculation of the image at the at least two spatial sampling frequencies; and an estimation component configured to estimate at least one of the signal components.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram illustrating a Bayer sensor array appropriate for embodiments of the present invention.

FIG. 3 is a block diagram illustrating a Bayer sensor array appropriate for embodiments of the present invention.

FIG. 4 is a block diagram illustrating a Bayer sensor array appropriate for embodiments of the present invention.

FIGS. 5A and 5B are block diagrams illustrating a Bayer sensor array appropriate for embodiments of the present invention

FIG. 6 is a flow diagram illustrating a method in accordance with an embodiment of the present application.

FIG. 7 is a illustrating a pyramid construction in accordance with an embodiment of the subject matter of the present application.

FIG. 8 is a flow diagram illustrating a method in accordance with an embodiment of the present application.

FIG. 9 is a flow diagram illustrating a method in accordance with an embodiment of the present application.

FIG. 10 is an image illustrating a blue channel created using a spatial phase grid such as described in FIG. 3 in accordance with an embodiment of the present invention.

FIG. 11 is an image illustrating a red channel created using a spatial phase grid such as described with reference to FIG. 4 in accordance with an embodiment of the present invention.

FIG. 12 is an image illustrating a blue-row green channel created using a spatial phase grid such as described with reference to FIG. 5A in accordance with an embodiment of the present invention.

FIG. 13 is an image illustrating a red-row green channel created using a spatial phase grid such as described with reference to FIG. 5B in accordance with an embodiment of the present invention.

FIG. 14 is an image illustrating a difference image created by subtracting the different green channels described with reference to FIGS. 5A and 5B in accordance with an embodiment of the present invention in accordance with an embodiment of the present invention.

FIG. 15 is an image illustrating a difference channel such as shown in FIG. 14 altered by subtracting a red plus blue channel in accordance with an embodiment of the present invention.

FIG. 16 is an image illustrating a red minus blue channel in accordance with an embodiment of the present invention.

FIG. 17 is an image illustrating an image with aliasing and/or noise reduced in accordance with an embodiment of the present invention.

FIG. 18 illustrates a mobile device in accordance with an embodiment of the present invention.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor or a Digital Signal Processor (DSP) chip (Integrated Circuits).

More particularly, the embodiments herein include methods related to optimizing a color matrix sensor, such as a Bayer array sensor. The methods provided are appropriate for any digital imaging system wherein anti-aliasing filtration is lacking, such as smaller cameras, cameras disposed within cell phones and the like.

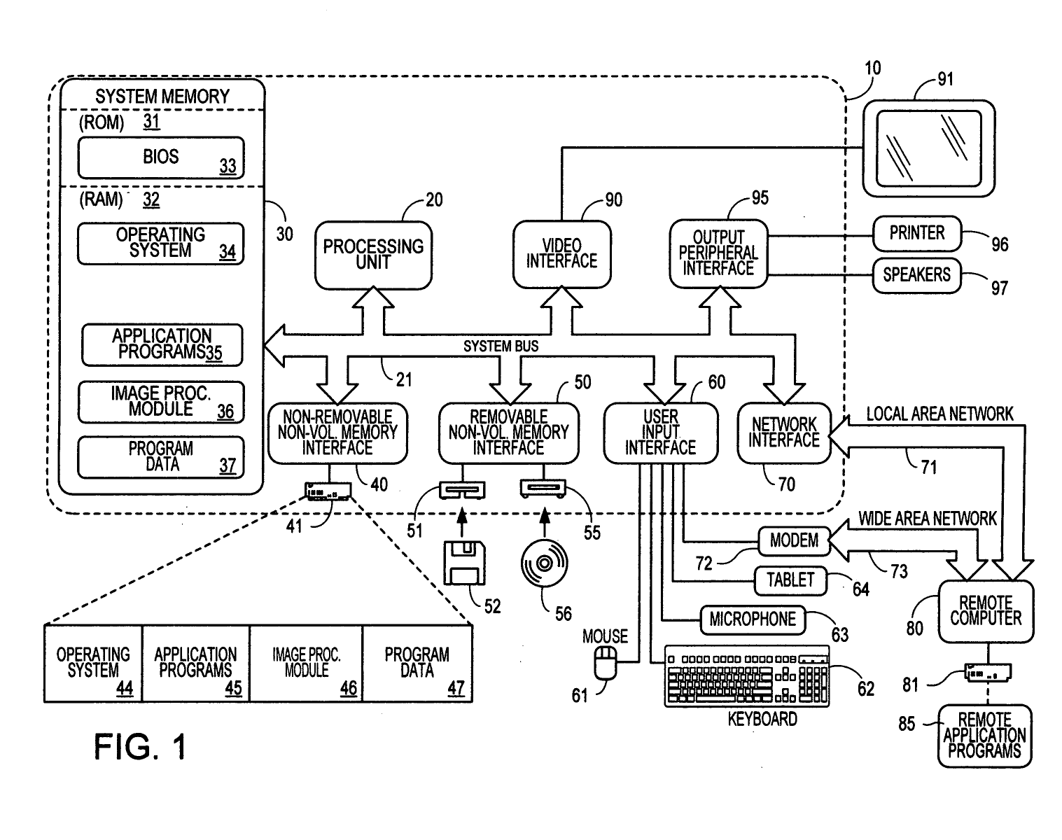

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular and/or mobile phone. In other embodiments, image processing modules could be part of a personal system on a hand-held device such as a personal digital assistant (PDA) and exist only in RAM and or ROM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

FIG. 1 illustrates program modules 36 and 46 that can be configured to include a computer program for reducing chroma-aliasing in images created using a color matrix sensor.

The image produced by a color matrix sensor is determined via collecting data a plurality of pixel points on the matrix sensor and interpolating to determine data unavailable via the collected data. The collected data is a sampling of a desired image. According to Nyquist, the sampling of the desired image at twice a highest frequency is necessary to avoid aliasing. In digital images, each pixel represented in a matrix array is a discrete sample of an original desired image. To avoid aliasing in the image, thus, the Nyquist sampling of the desired image is at twice the highest spatial frequency of the desired image.

If twice the highest spatial frequency of a desired image requires undersampling, aliasing manifests itself through high-frequency noise components appearing as low-frequency signal components. Thus, low-frequency patterns can appear scattered throughout an image. Imperfect reconstruction also causes aliasing by introducing false high frequency components into an image.

Aliasing caused by sampling and reconstruction can be seen at edges in a digital image. False low frequency components from undersampling can cause Moiré patterns; the false high frequency components from imperfect reconstruction can appear as jagged edges that follows a pixel grid.

One method of reconstructing the desired image is to convolve the sampled image, including a plurality of signal components and a plurality of noise components with the inverse transform of a rect function. The inverse transform of a rect function is a sinc function. A sinc functions is infinite however, requiring band limiting or the like. Since an infinite function is unavailable, additional copies of data get shifted to higher frequencies, thereby introducing false high frequency components that appear as aliasing.

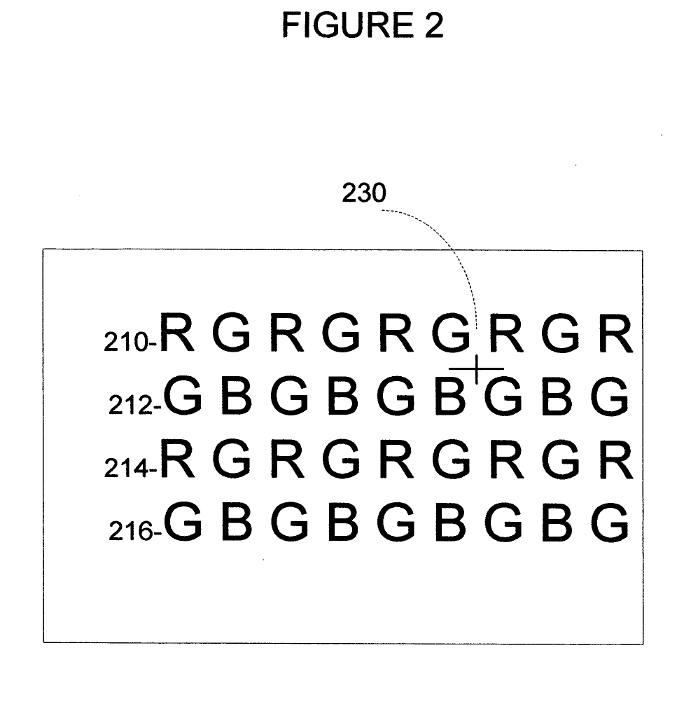

The Nyquist effects causing aliasing can be described with reference to a color matrix sensor. Specifically, referring now to FIG. 2, a color matrix sensor is provided appropriate for imaging, such as a Bayer array sensor. As shown, 25% of the pixels are red, 25% are blue, and 50% of the pixel sensors are green. In a matrix sensor, such as a Bayer-arrayed sensor, color is encoded according to a pattern of colored filters.

In a Bayer array, illumination of only even sensors on even rows, 212 and 216 may encode blue. However, there is a significant statistical likelihood that an alignment will occur such that some sensors will decode blue by chance. For example, a distant building detected on some sensors may have windows also recorded on the same sensors, possibly causing the windows to decode as blue. The effect of the incorrect sensing is in effect akin to undersampling of the real world and according to Nyquist theories produces spurious rainbows called chroma aliasing. Similarly, if the filter is not aligned over the sensor, the red row greens, rows 210 and 214, detect different light than the blue-row greens 212 and 216. The effect of a misaligned filter is that the real world is not sampled correctly, thereby producing noise in an image.

Thus, due to the physical limitations of a color matrix array, the green sensors on all rows 210, 212, 214 and 216 do not necessarily detect the same light. Any processing that assumes that each green sensor detects the light the same regardless of the surrounding pixel color makes an incorrect assumption and artifacts, aliasing and the other image problems result.

One type of anti-aliasing filter corrects aliasing by essentially blurring at an aliasing frequency. Other anti-aliasing filters attempt to address aliasing by applying filters that allow a spread of sensors to detect light. Other anti-aliasing filters attempt to direct the aliasing to higher less detectable frequencies. The best kind of anti-aliasing filter, a sinc type filter, requires a negative excursion component which is physically impossible in optics. Thus, in optics, typical anti-aliasing filters blur an image to reduce aliasing or reduce the magnitude of the aliasing. Another technique is to work in the frequency domain and determine frequencies at which aliasing occurs with the greatest magnitude.

In a Bayer array, such as the array shown in FIG. 2, two alternate rows of green correspond to red-row-green 210 and blue-row-green 212. The two alternate rows should yield substantially the same image if behind a good anti-aliasing filter. However, without such a filter, there will be differences between the frequencies, when viewed in a time-frequency domain. An alias can be caused by an unwanted difference between the blue sensors and the red sensors because they are sensing different parts of an image. Thus, even a black and white pattern causes sensors to detect a color pattern, for example, by hitting the blue sensors more than the red sensors.

One problem with anti-aliasing techniques is that they reduce aliasing effects only at lower frequencies. At higher frequencies, a Moire effect is the result, showing a shimmer effect, or different colors in a striped shirt or the like.

Cameras with a pastelized filter, or lighter colored filters, do not affect aliasing by making the aliasing any weaker. If red is dark red, etc, bright colors will result and low light will not be sensitive. Aliasing is independent of the type of filter, with the brightness effect of the filter being directly proportional to the amount of aliasing.

One problem with a Bayer array and other color matrix sensors is that blue and red channels have twice as much aliasing than the green channel because the green channel has more sensors in a Bayer array. Without an anti-aliasing filter, the result in a single point, for example a point hitting point 230, the sensor for a small point depends on the sensor that picked up that point. A blurring anti-aliasing filter will cause point 230 to be spread and be picked up by more sensors by interpolation/demosaicing.

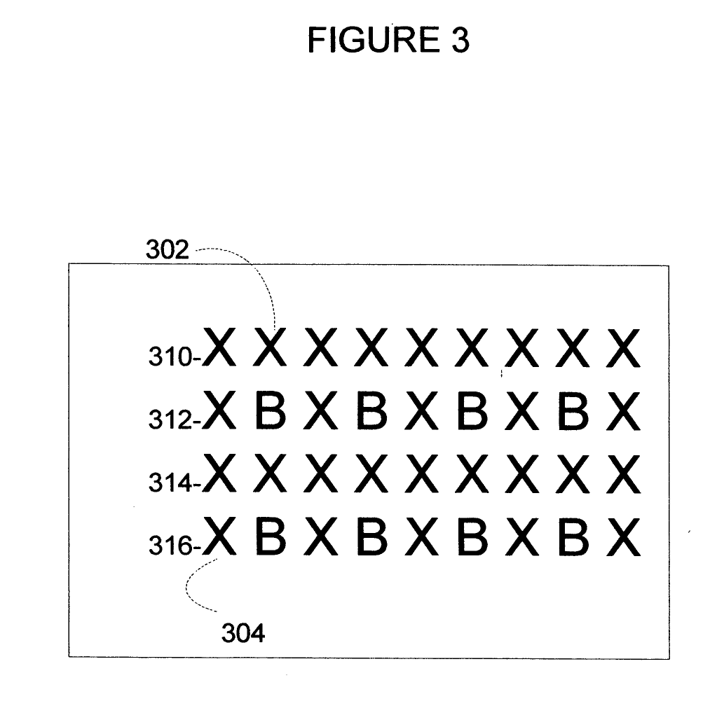

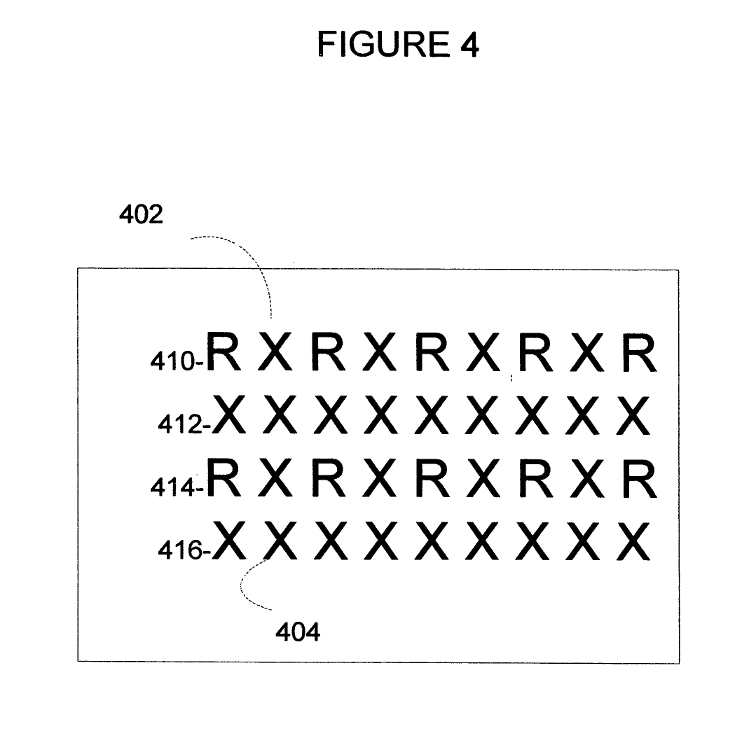

Referring now to FIG. 3 in combination with FIG. 4, a method for reducing aliasing and noise in a collected image is described with reference to a spatial phase separation method. FIG. 3 illustrates a grid that applies to an array to separate pixel data into a plurality of spatial phases. More particularly, one way of separating an array is as a function of how a lens in combination with a pixel array determines color channels. As shown in FIG. 3, a spatial representation of a red phase can be produced by filtering all but the red pixels. A grid is shown that is applied to separate the data collected by a lens by blocking all but the red pixel data. As shown, the red data 302 is separated from blue and green data, marked with an “X” 304. The same grid that filters all but the red pixels can be altered spatially by moving the grid to expose only the blue pixels. The result of spatially moving the grid is that a spatial phase alteration occurs to produce in only the blue pixel data. Referring to FIG. 4, the blue data 402 is separated from red and green data, as marked with an “X” 404. Note that the grid is a spatial phase alteration from the grid used to expose only red pixel data in that the data allowed to pass is a 45 degree shift from the data passed to allow the red pixel data.

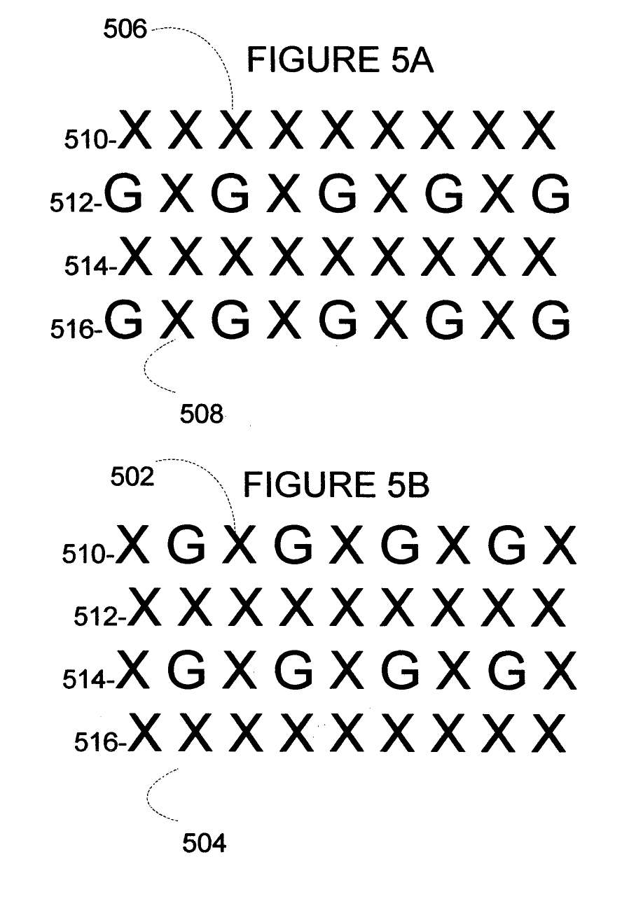

Similarly, the same grid can be applied to isolate green pixel data. More particularly, according to an embodiment, a spatial phase separation technique can separate different types of green pixel data. As shown, the same grid used to expose only the red pixel data can spatially alter the exposed pixel data through a spatial shift to the right or left to expose only the red-row green pixel data. FIG. 5 illustrates a grid wherein only the red-row green pixels are exposed in rows 510, 512, 516, and 518. Similarly, the grid spatially shifted upward or downward results in exposing only the blue-row green pixel data. Although the array has more pixels dedicated to green, in the embodiment only ¼ of the green pixel data is permitted to pass using the grid to create a spatial phase separation between the two types of green pixel data. As a result, in one embodiment, the spatial phases created using the grid are red, blue, red-row green and blue-row green. As one of skill the art with the benefit of this disclosure will appreciate, the spatial phases of any array for which similar color channels are dedicated more array space than other color channels of the pixel area of the array are appropriate for the methods disclosed herein.

After isolating each color channel with a same grid, the spatial phases can be subjected to a interpolation/demosaic process to achieve an independent pixel definition for an image. As a result, four spatial color phases are achieved. As will be appreciated by one of skill in the art with the benefit of the disclosure, the color information does not change by the interpolation/demosaic process, but the noise changes because each color is represented by an independent group of sensors and each sensor is statistically independent with its own noise. Changes due to aliasing and noise are thereby isolated. Next, according to an embodiment, the two spatial phases generated that relate to a same and/or similar color are compared. For example, the two spatial phases of green (red-row green and blue-row green) are compared. Any difference between the two spatial phases can be used to identify aliasing and/or noise.

In one embodiment, the spatial phases are altered to generate standard color channels, such as a YIQ color definition or the like. For example, an I channel can be defined as the red spatial phase data minus the blue spatial phase data; a Q channel can be defined as the green minus magenta spatial phase data and/or the magenta minus green spatial phase data. More specifically, the Q channel can be defined as red-row green spatial phase data plus the blue-row green spatial phase data, then dividing the result by the red spatial phase data and the blue spatial phase data. The result of the division can then be normalized. A Y channel can be defined as a normalized sum of all the color spatial phase data.

Color noise and aliasing can be found via a GG channel found by subtracting a red-row green spatial phase from a blue-row green spatial phase.

In one embodiment, the GG channel is used to remove aliasing and noise prior to constructing a standard color channel definition. More particularly, a YUV color definition can be determined after aliasing and noise is removed. As will be appreciated by one of skill in the art, a YUV color definition is a blend of the color phases that does not provide the information necessary to remove aliasing or noise due to the U channel having data at all higher frequencies. Specifically, a GG channel containing the noise and aliasing and an I channel contain data at same frequencies that are separated only by spatial phases as herein described. Thus, removing the aliasing and noise prior to constructing a YUV color definition is necessary.

As is known, an I channel is most subject to aliasing and can benefit from embodiments disclosed herein due to aliasing caused by a pattern projected by the lens on the sampling grid. If a same sampling grid offset in position is subjected to a same type of interference, the result is displaced in spatial phase and not in frequency. Thus, any noise in the I channel is independent and can be identified using the embodiments disclosed herein.

After separation of color spatial phases is determined, an embodiment provides for creating a map of aliases. For example, the GG channel can be examined by determining an absolute value, applying a high pass filter or applying a pyramid structure to separate different aliasing/noise at different frequencies. In one embodiment, a high pass filter is applied to avoid determining that differences between color channels that relate to image data are aliasing or noise.

Further, the filtered GG channel data can be used to separate aliasing data from noise data. For example, a defined I channel can be manipulated by applying a low pass filter, such as a median filter to isolate image data. Next, one or more high pass filters can be applied to the I channel to isolate image data subject to aliasing and/or noise. The separated I channel data can then be manipulated to remove noise and aliasing by using the GG channel. Thus, for example, a GG channel isolated to identify high-pass noise and/or aliasing can be subtracted from the high pass I channel data. The high pass data can be used to identify the energy content in a given color channel. More particularly, the energy content can be defined by taking the absolute value of a given channel and applying smoothing filter.

Once the energy content of the GG channel and the I channel are isolated, comparisons can made to identify aliasing. For example, if luminance similarities are noted, an assumption can be made that the data represents signal and not aliasing. If, on the other hand, lighter areas appear in the I channel and not in a GG channel, the difference can be assumed to be attributable to aliasing.

In one embodiment, the aliasing is located by dividing data identified as representing the energy in the I channel by the data identified as representing the energy in the GG channel. The division can be accomplished at varying thresholds to provide high frequencies free of aliasing and noise at different magnitudes. Because noise changes with color and temperature and the like, the GG channel provides a threshold that enables removal of noise while allowing fine detail to remain.

The methods according to embodiments herein can be programmed in C code or other code appropriate for image processing as is known. Below, a pseudo-code representation illustrates one implementation of the embodiments disclosed herein. As shown, the pseudo-code assumes a Bayer array is used to collect digital camera data. However, other arrays that collect data by differentiating the number of pixels dedicated to a same and/or similar color as opposed to other colors are appropriate for the methods disclosed herein. As described below, an array is defined “N” which represents the red-row green data minus the blue-row green data.

#define Width 1024 // image width
#define Height 768 // image height
#define Levels 5 // number of pyramid levels
// it is assumed that the Bayer array contains the raw output
// from a digital camera with a Bayer filter in front of the sensor
int Bayer[Height][Width];
// arrays for each of the color planes
int Red[Height][Width]; // Red
int Gred[Height][Width]; // red row Green
int Gblue[Height][Width]; // blue row Green
int Blue[Height][Width]; // Blue
// pointers to arrays at each level in hi-pass YIQN space
int *Yhi[Levels];
int *Ihi[Levels];
int *Qhi[Levels];
int *Nhi[Levels];
// pointers to arrays at each level in lo-pass YIQN space
int *Ylo[Levels];
int *Ilo[Levels];
int *Qlo[Levels];
int *Nlo[Levels];
// pointers to arrays at each level for envelope data
int *Ienv[Levels];
int *Qenv[Levels];
int *Nenv[Levels];
int main( )
{

// Separate the Bayer array into four sparse arrays:
// Red, red row Green, blue row Green, and Blue
BayerToRGGB( );
// Demosaic the RGGB arrays to fill in the missing data
LowPassFilter(Red);
LowPassFilter(Gred);
LowPassFilter(Gblue);
LowPassFilter(Blue);
// Allocate memory for the YIQN arrays
// each level will be ½ the size of the one above it
for(i = 0; i < Levels; i++)

{

Yhi[i] = new int [Height >> i][Width >> i];
Ihi[i] = new int [Height >> i][Width >> i];
Qhi[i] = new int [Height >> i][Width >> i];
Nhi[i] = new int [Height >> i][Width >> i];
Ylo[i] = new int [Height >> i][Width >> i];
Ilo[i] = new int [Height >> i][Width >> i];
Qlo[i] = new int [Height >> i][Width >> i];
Nlo[i] = new int [Height >> i][Width >> i];
Ienv[i] = new int [Height >> i][Width >> i];
Qenv[i] = new int [Height >> i] [Width >> i];
Nenv[i] = new int [Height >> i][ Width >> i];

}

// Convert the RGGB data into the top level YIQN data
// Data is temporarily stored as lo-pass
for(row = 0; row < Height; row++)

{

for(col = 0; col < Width; col++)

{

R = Red[row][col];
Gr = Gred[row][col];
Gb = Gblue[row][col];
B = Blue[row][col];
Ylo[0][row][col] = R + Gr + Gb + B;
Ilo[0][row][col] = R − B;
Qlo[0][row][col] = R − Gr − Gb + B;
Nlo[0][row][col] = Gr − Gb;

}
}

// Separate the YIQN data into hi-pass and low pass arrays
// Copy the low pass data to the next lower level at ½ size
// and repeat the hi/lo separation
for(i = 0; i < Levels − 1; i++)

{

Yhi[i] = HighPassFilter(Ylo[i]);
Ylo[i] = LowPassFilter(Ylo[i]);
Ihi[i] = HighPassFilter(Ilo[i]);
Ilo[i] = LowPassFilter(Ilo[i]);
Qhi[i] = HighPassFilter(Qlo[i]);
Qlo[i] = LowPassFilter(Qlo[i]);
Nhi[i] = HighPassFilter(Nlo[i]);
Nlo[i] = LowPassFilter(Nlo[i]);
Ylo[i + 1] = Downsize(Ylo[i]);
Ilo[i + 1] = Downsize(Ilo[i]);
Qlo[i + 1] = Downsize(Qlo[i]);
Nlo[i + 1] = Downsize(Nlo[i]);

}

// At each level but the lowest, calculate the envelopes
// for the hi-pass I, Q, and N data
for(i = 0; i < Levels − 1; i++)

{

Ienv[i] = LowPassFilter(AbsoluteValue(Ihi[i]));
Qenv[i] = LowPassFilter(AbsoluteValue(Qhi[i]));
Nenv[i] = LowPassFilter(AbsoluteValue(Nhi[i]));

}

// At each level but the lowest, adjust the I and Q hi-pass
// data according to the envelope ratio with N data
for(i = 0; i < Levels − 1; i++)

{

for(row = 0; row < (Height >> i); row++)

{

for(col = 0; col < (Width >> i); col++)

{

if(!Nenv[i][row][col]) continue;
ratio = Ienv[i][row][col] /
Nenv[i][row][col];
Ihi[i][row][col] = TransferFunction(row,
col, ratio);
ratio = Qenv[i][row][col] /
Nenv[i][row][col];
Qhi[i][row][col] = TransferFunction(row,
col, ratio);

}

}
}

// Starting at the lowest level add the data back up to the top
// The lower level data needs to double in size to match the level
// above it
for(i = Levels − 2; i >= 0; i−−)

{

Ilo[i] = ArraySum(Upsize(Ilo[i + 1]), Ihi[i]);
Qlo[i] = ArraySum(Upsize(Qlo[i + 1]), Qhi[i]);

}

// Convert the uppermost level YIQN data back to RGGB
for(row = 0; row < Height; row++)

{

for(col = 0; col < Width; col++)

{

Y = Ylo[0][row][col];
I = Ilo[0][row][col];
Q = Qlo[0][row][col];
N = Nlo[0][row][col];
Red[row][col] = (Y + 2*I + Q) / 4;
Blue[row][col] = (Y − 2*I + Q) / 4;
Gred[row][col] = (Y − Q + 2*N) / 4;
Gblue[row][col] = Gred − N;

}
}

// The image is now corrected and can be output as desired
SaveToFile( );

}

The pseudo-code provided above provides a difference measure used to calculate noise and aliasing via an “N array” to represent noise and/or aliasing components of an image. The N array can represent basis functions of an image resulting from using the spatial phase technique described above with respect to FIGS. 2, 3 4, 5A and 5B. In particular, the spatial phases of the blue-row green and the red-row green can be expressed in terms of basis functions and/or manipulated in the form of an array. The N array described in the pseudo-code is a difference measure of the spatial phases chosen to be the blue-row green spatial phase and the red-row green spatial phase. The N array is used to demosaic an image. One of skill in the art with the benefit of the present disclosure will appreciate, however, that the resulting removal of noise and/or aliasing components can be achieved using any color and performing the difference calculation with another color of shared color spectrum frequencies that has a different spatial phase from the color. One example of another color having a shared color spectrum frequency with green can be a green-magenta color.

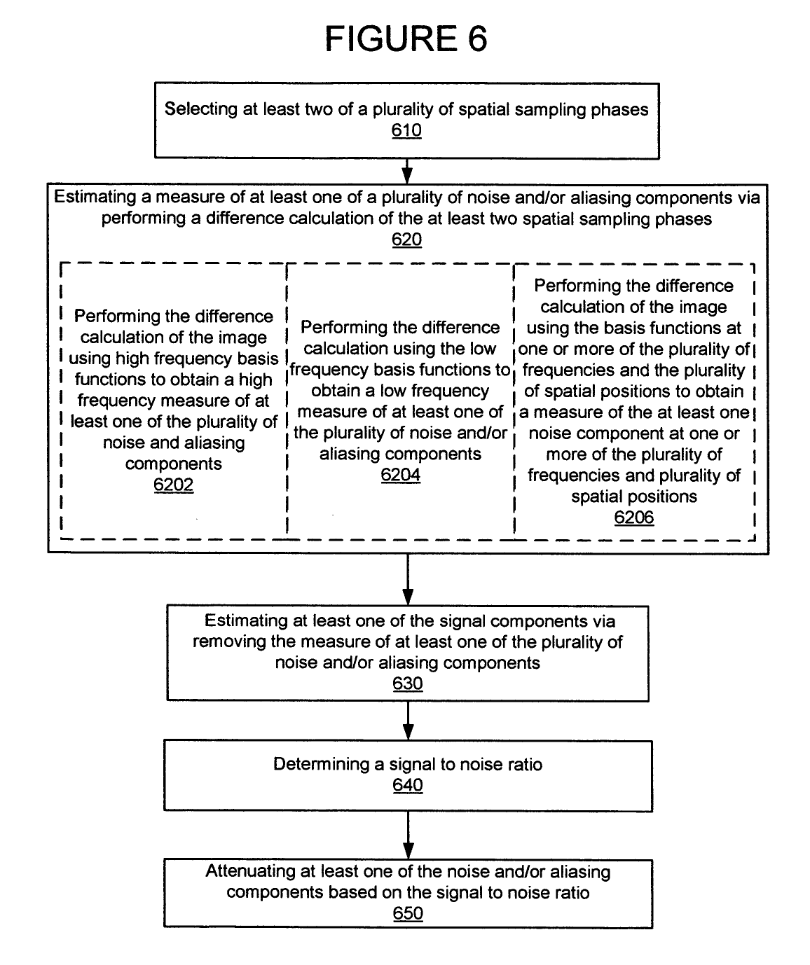

Referring now to FIG. 6, a flow diagram illustrates a method for reducing noise and/or aliasing from an image received at a color matrix array, such as the array described with respect to FIG. 2. The color matrix array could be a Bayer matrix array or another matrix array appropriate for collecting image data. The collected image data can be sampled in a plurality of spatial sampling frequencies. The image received via the matrix array results in an image including image components and noise and/or aliasing components.

FIG. 6 illustrates a method for reducing the noise and aliasing components, the noise including artifacts. Block 610 provides for selecting at least two of a plurality of spatial phases, such as those collected using the grid described above with respect to FIGS. 3, 4, 5A and 5B. The two spatial phases must relate to each other by having a same or similar color channel, such as red-row green and blue-row green. In one embodiment, the plurality of signal components, noise and/or aliasing components is represented by a plurality of basis functions the plurality of basis functions representing the image in frequency and spatial position.

Block 620 provides for estimating a measure of at least one of the plurality of noise and/or aliasing components via performing a difference calculation of the at least two spatial phases.

In one embodiment, the basis functions are defined in at least a high frequency and a low frequency to generate one or more high frequency basis functions and one or more low frequency basis functions. According to the embodiment, the measure of at least one of the plurality of noise and/or aliasing components is determined as shown in optional blocks 6202 and 6204. More particularly, block 6202 provides for performing the difference calculation of the spatial phases, restricting the data to the high frequency basis functions to obtain a high frequency measure of at least one of the plurality of noise components. Block 6204 provides for performing the difference calculation of the image using the low frequency basis functions to obtain a low frequency measure of at least one of the plurality of noise and/or aliasing components.

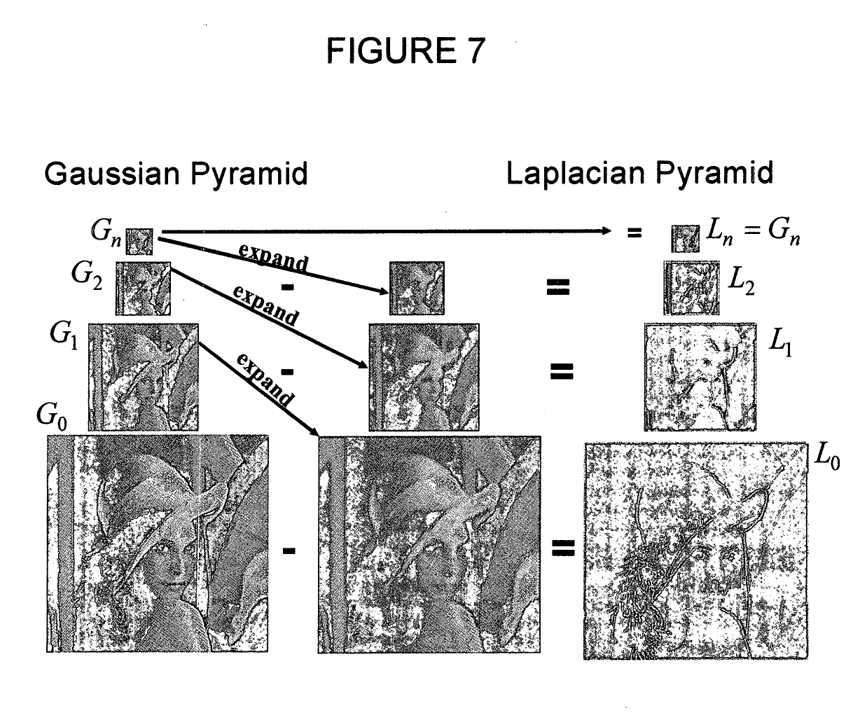

In another embodiment, the basis functions that are defined in a plurality of frequencies and in a plurality of spatial positions are used to measure at least one of the plurality of noise and/or aliasing components. Instead of high frequency and low frequency basis functions, a pyramid structure can be used to determine the measure of the noise components. A pyramid structure for determining the measure of the noise components can include a Gaussian pyramid and/or a Laplacian pyramid to enable reconstruction of an image by breaking down an image into high frequency and low frequency components. More particularly, referring to FIG. 7, Gaussian low pass components are shown by G₀, G₁, G₂ and Gₙ. Likewise high frequency components are shown by L₀, L₁, L₂ and Lₙ In an embodiment, noise component attenuation is performed on the images shown by G₁, G₂ and Gₙ and L₀, L₁, L₂ and Lₙ.

Referring back to FIG. 6 the pyramid structure can be applied prior to determining difference calculations. As shown, optional block 6206 provides for performing the difference calculation of the image using the basis functions at one or more of the plurality of frequencies to obtain a measure of the at least one noise component at one or more of the plurality of frequencies.

The performing the difference calculation using the basis functions at one or more of the plurality of frequencies to obtain a measure of the at least one noise and/or aliasing component at the plurality of frequencies can include determining a magnitude representative of the basis functions at the one or more of the plurality of frequencies.

Block 630 provides for estimating at least one of the signal components via removing the measure of at least one of the plurality of noise and/or aliasing components.

Block 640 provides that the performing the difference calculation using the basis functions at one or more of the plurality of spatial phases to obtain a measure of the at least one noise component at the plurality of frequencies and plurality of spatial positions includes determining a signal to noise ratio; and, at block 650, attenuating the at least one noise and/or aliasing component based on the signal to noise ratio.

The attenuating the at least one noise component based on the signal to noise ratio can include attenuating the at least one noise and/or aliasing component if the signal to noise ratio is approximately at least 1.0. Alternatively, the attenuating the at least one noise and/or aliasing component based on the signal to noise ratio can include attenuating the at least one noise and/or aliasing component if the signal to noise ratio is at least a predetermined inflection point. Alternatively, the attenuating the at least one noise and/or aliasing component based on the signal to noise ratio can include attenuating one or more of the plurality of basis functions representing the image in frequency and spatial phases. More specifically, in an embodiment, the attenuating one or more of the plurality of basis functions representing the image in frequency and spatial phases can include determining a channel represented by the one or more of the basis functions, and using a correlated difference measure to determine the attenuating the at least one noise component based on the signal to noise ratio for the channel.

Channels appropriate for embodiments described herein can include an I channel, a Q channel, and a Y channel. The Y channel is one or more basis functions of image data that represent the perceived luminance. The I channel is an “in-phase” component of one or more basis functions that represents color information and some luminance. The Q channel is one or more basis functions that represent a quadrature component of color information and some luminance

Luminance noise and chrominance noise in a digital image can be located in the high frequency components of an image, such as those shown in L(0)-L(n) in difference images. Because noise reductions are performed to the smaller image and do not affect the high frequency details kept in the difference images, the luminance noise and chrominance levels in other frequencies are not affected.

The correlated difference measure for the I channel can be determined via performing the difference calculation of the spatial phases using the basis functions at one or more of the plurality of frequencies and the spatial phases, the difference measure including one or more basis functions representing a red component and one or more basis functions representing a blue component. The difference measure can include one or more basis functions representing a first green component and a second green component, such as described with reference to FIGS. 5A and 5B.

The correlated difference measure for the Q channel can be determined via performing the difference calculation of the image using the spatial phases such as red-row green and blue-row green. Alternatively, the difference measure can include one or more basis functions representing a green-magenta component.

The one or more basis functions representing the green-magenta component can be altered via determining a first magnitude of the correlated difference measure between a first green component and a second green component; determining a second magnitude of the correlated difference measure between a red component and a blue component; and attenuating the green-magenta component based on an average of the first magnitude and the second magnitude.

The correlated difference measure for the Y channel can be determined via performing the difference calculation of the image using the basis functions at one or more of the plurality of spatial phases, the difference measure including one or more basis functions representing a red-green component and a green-blue component. More particularly, the one or more basis functions representing the red-green component and the green-blue component can be altered via determining a magnitude of the correlated difference measure between a first green component and a second green component, the first green component and the second green component limited to frequencies below a predetermined frequency; and attenuating red-green component and the green-blue component based on an average of the first magnitude and the magnitude.

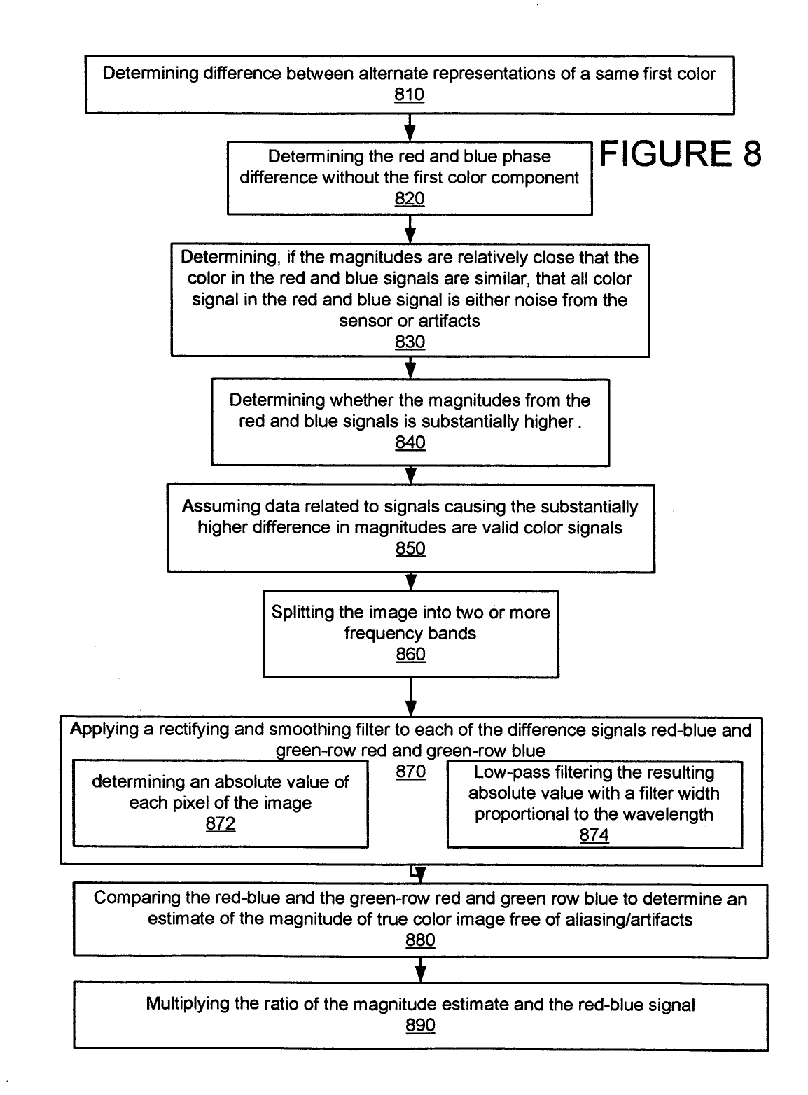

Referring now to FIG. 8, a flow diagram illustrates an alternate method in accordance with an embodiment. In the embodiment, different representations of a same color component are used to determine a difference calculation. For example a cyan-cyan difference with respect to alternate cyan representations is appropriate in one embodiment. Block 810 provides for determining difference between the alternate representations of a same or similar first color. For example, in FIG. 2, green corresponds to the two rows of red-row green 210 and 214 and blue-row green 212 and 216. Note that if an adequate anti-aliasing filter is applied, the resulting image created by the alternate representations of green will yield substantially the same image. However, without an anti-aliasing filter, there will be differences between the representations. The difference between the representations is a magnitude representing the spurious difference between the red and blue representations. Note that for horizontal and vertical artifacts, the resulting difference will either be 180 degrees anti-phased and for diagonal artifacts, the resulting difference will be 0 degrees phased, thus, magnitudes are appropriate.

Block 820 provides for determining the red and blue difference without the first color component. The red-blue phase difference can define the “I” channel. Alternatively, to determine the red-blue phase difference, two different color vectors can be compared.

Block 830 provides for determining, if the magnitudes are relatively close in that the color in the red and blue signals are similar, that all color signal in the red and blue signal is either noise from the sensor or artifacts.

Block 840 provides for determining whether the magnitudes from the red and blue signals are substantially higher than the difference between the alternate representations of the first color.

Block 850 provides for assuming data related to signals causing the substantially higher difference in magnitudes are valid color signals.

Block 860 provides for splitting the image into two or more frequencies. In one embodiment, a pyramid structure can be used as described above. In another embodiment, the image is split into a high frequency component and a lower frequency component. If a pyramid structure is used, a recursive approach can be applied to the different pyramid components, as one of skill in the art with the benefit of the present disclosure will appreciate.

Block 870 provides for applying a rectifying and smoothing filter to each of the difference signals, such as red-blue and green-row red and green-row blue. More specifically, to rectify and smooth, block 872 provides for determining an absolute value of each pixel of the image. Block 874 provides for low-pass filtering the resulting absolute value with a filter width proportional to the wavelength. The resulting image represents the magnitude of aliases at each point, such as in the green-row red and green-row blue; and the sum of aliases and actual image color magnitude in the red-blue image, respectively.

Block 880 provides for comparing the red-blue and the green-row red and green row blue to determine an estimate of the magnitude of true color image free of aliasing/artifacts.

Block 890 provides for multiplying the ratio of the magnitude estimate and the red-blue signal. More specifically, because the “I” channel is more pervasive than the green-magenta “Q” channel, the result represents the gain that should be applied to all color information. For example, the same band of U and V color vectors in a YUV system, or two or more color components, different from red-blue, which can also be tracked independently.

For example, if the envelope magnitude of red-blue is much larger than the green-row-red/green-row blue, the color gain approaches 1.0. A 1.0 gain implies a valid signal to be preserved. As the envelope magnitude approaches parity, however, the gain tends toward zero, indicating that the perceived color is more likely aliasing or sensor noise.

Multiplying by a gain of less than one is equivalent to making a color signal more transparent and causing an underlying color to be revealed. In the case of a simple bandpass or pyramid application, the underlying color can be a zero signal, or lack of color. In another embodiment, the underlying color can be from lower spatial frequencies. Thus, higher frequency colors can be made more transparent, while lower spatial frequency colors can be preserved. For lower spatial frequencies, a low pass filter can be ápplied to exclude areas from a low pass average that have been previously determined by the multiplicative gain to be inundated with aliasing or noise.

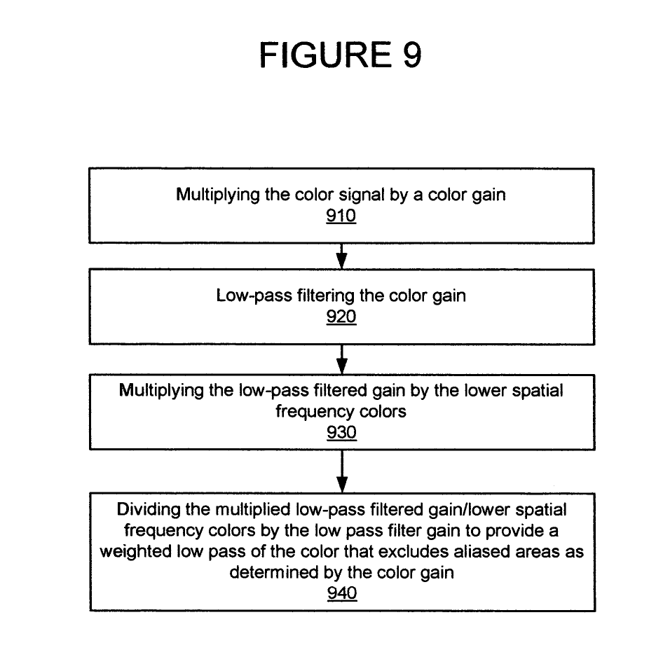

Referring to FIG. 9, a method for averaging low frequency signals is illustrated. Block 910 provides for multiplying the color signal by a color gain. Block 620 provides for low pass filtering the color gain.

Block 930 provides for multiplying the low-pass filtered gain by the lower spatial phase frequency colors.

Block 940 provides for dividing the multiplied low-pass filtered gain/lower spatial frequency colors by the low pass filter gain to provide a weighted low pass of the color that excludes aliased areas as determined by the color gain.

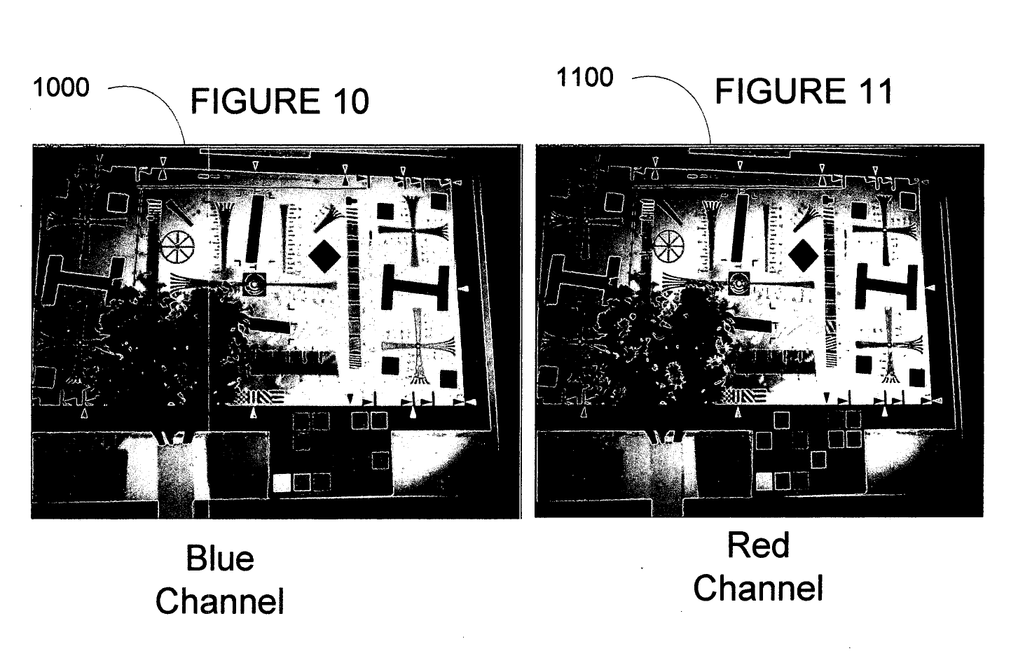

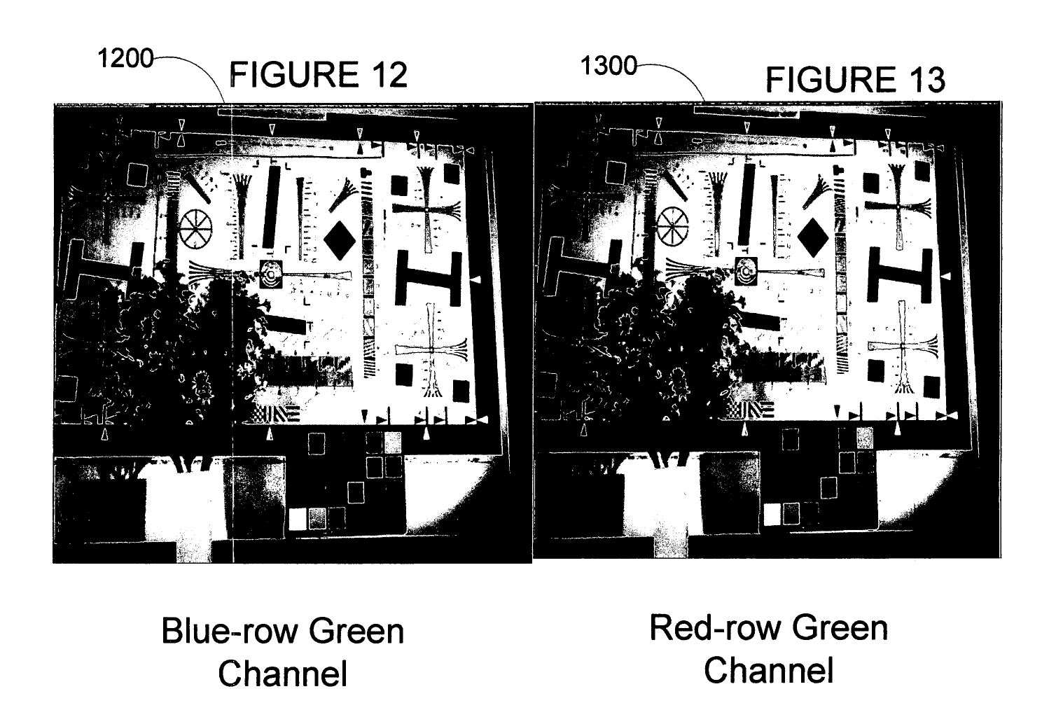

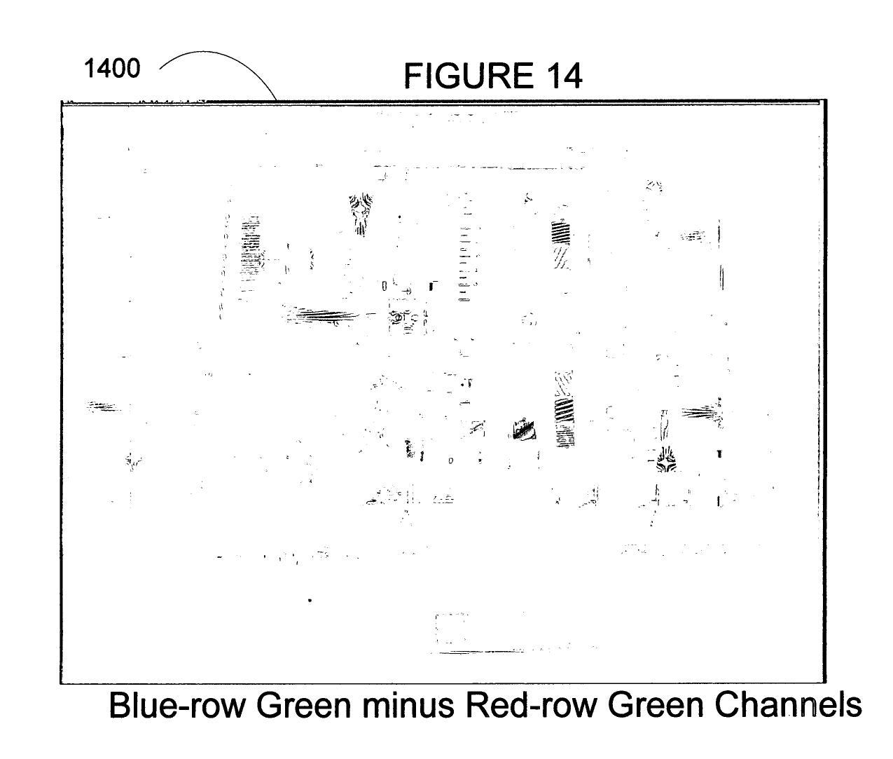

Referring now to FIGS. 10 through 16, images of different color channels according to embodiments disclosed herein are provided. FIG. 10 is an image illustrating a blue channel 1000 created using a spatial phase grid such as described in FIG. 3. FIG. 11 is an image illustrating a red channel 1100 created using a spatial phase grid such as described with reference to FIG. 4. FIG. 12 is an image illustrating a blue-row green channel 1200 created using a spatial phase grid such as described with reference to FIG. 5A. FIG. 13 is an image illustrating a red-row green channel 1300 created using a spatial phase grid such as described with reference to FIG. 5B. FIG. 14 is an image illustrating a difference image created by subtracting the different green channels described with reference to FIGS. 5A and 5B. Image 1400 is a representation of a GG channel which can also be created via the pseudo-code “N array”.

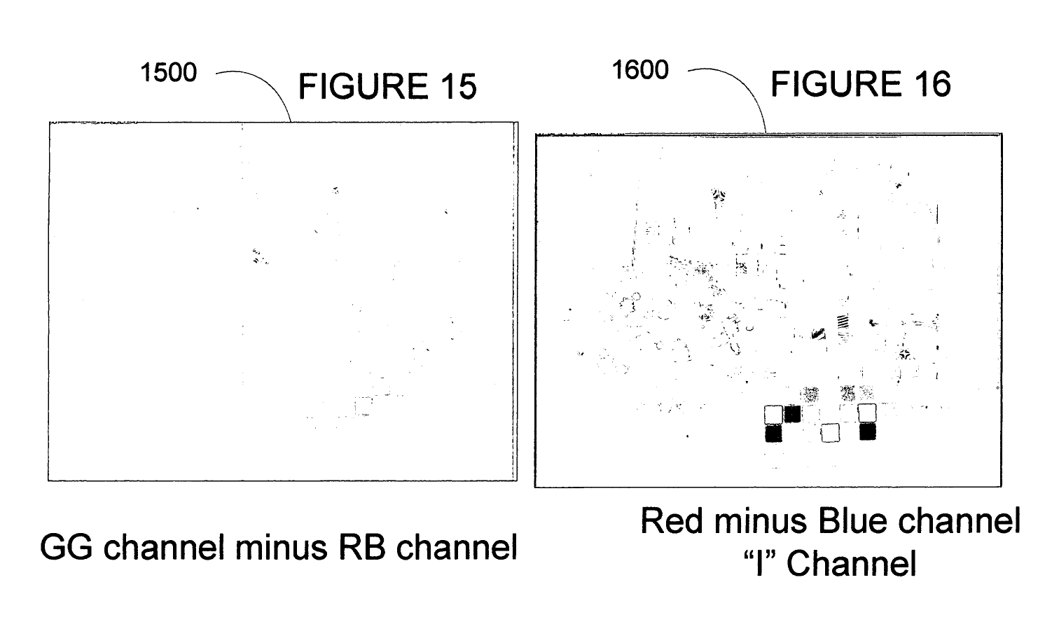

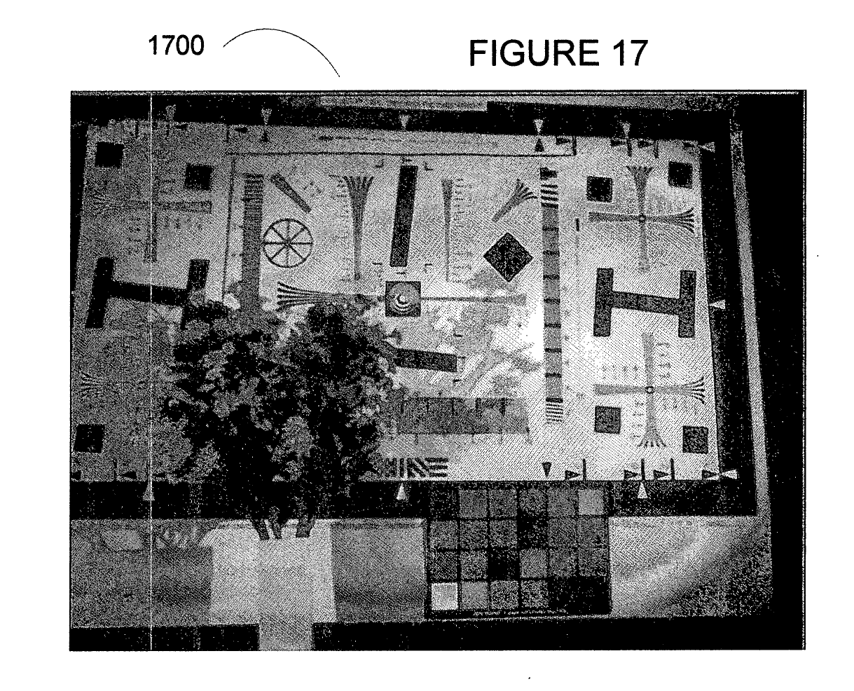

FIG. 15 is an image 1500 illustrating a difference channel such as shown in FIG. 14 altered by subtracting a red plus blue channel. FIG. 16 is an image 1600 illustrating a red minus blue channel, demonstrating an “I” channel. As can be seen, images 1500 and 1600 demonstrate that noise and/or aliasing has been substantially reduced. More particularly, referring to FIG. 17, image 1700 illustrates a final image with aliasing and/or noise substantially reduced.

It will be apparent to those skilled in the art that many other alternate embodiments of the present invention are possible without departing from its broader spirit and scope. Moreover, in other embodiments the methods and systems presented can be applied to other types of signal than signals associated with camera images, comprising, for example, medical signals and video signals.

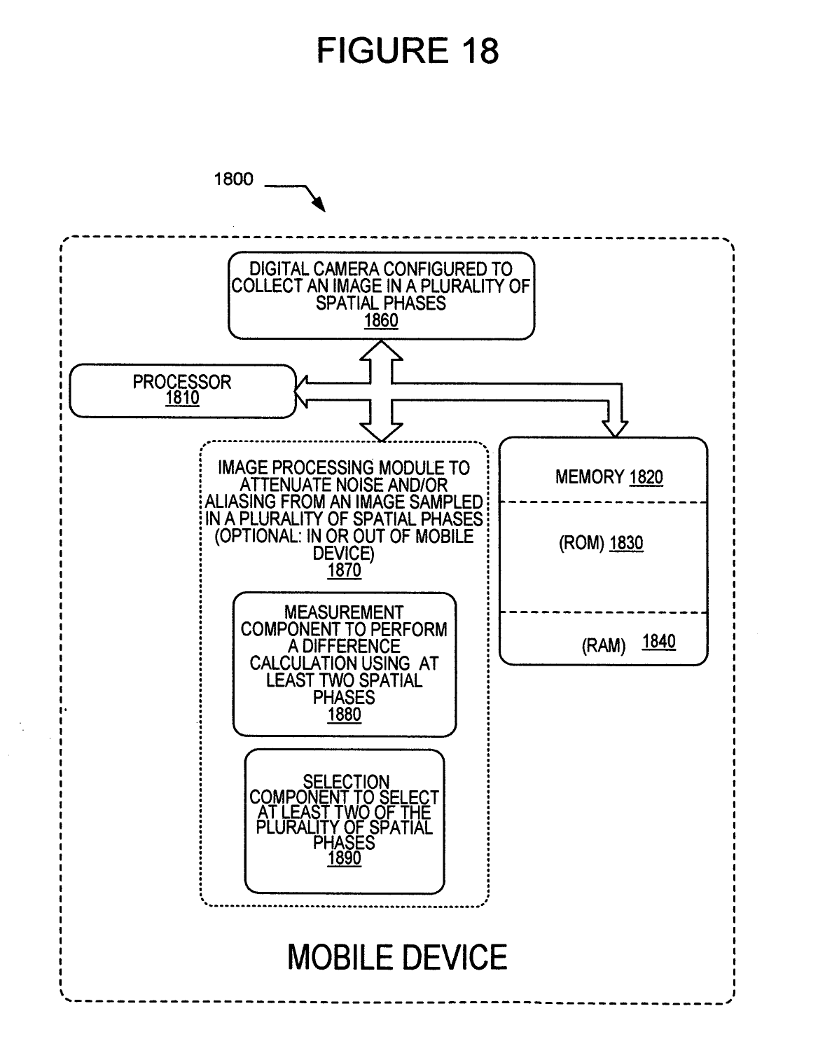

According to an embodiment, images can have noise and/or aliasing components reduced performed in a mobile device. The mobile device can be a cellular/mobile telephone, a personal digital assistant, a mobile computing device, such as a notebook computer, tablet computer, or the like. Referring to FIG. 18, a mobile device 1800 appropriate for implementing an embodiment is illustrated. FIG. 18 illustrates an embodiment in which the mobile device 1800 can include a processor 1810, a memory 120 coupled to the processor and an image processing module 1870. Memory 1820 can include read-only memory (ROM) 1830 and/or read and write (RAM) memory 1840. In one embodiment, mobile device 1800 can include a digital camera to collect an image in a plurality of spatial phases 1860. Mobile device 1800 is illustrating including an image processing module 1870 including a measurement component to perform a difference calculation of an image using at least two spatial phases, the difference calculation to identify noise and/or aliasing 1880; and a selection component to select at least two of the plurality of spatial phases 1890. According to an embodiment, the selection component selects at least two of the plurality of spatial phases for the measurement component to perform a difference calculation. The difference calculation can then be used to remove noise and/or aliasing from the image.

In one embodiment, the image processing module 1870 removes aliasing and/or noise by creating one or more Gaussian images G(n) and/or on one or more Laplacian images L(n) according the type of enhancement required or desired. In one embodiment, the level of noise attenuation is determined as a function of the processing time required for performing the enhancements. For example, in some systems, such as cell phone environments and the like, the enhancements allowable for images is limited by the processing time permitted in a system. In other systems, enhancements to be performed in near real time are severely limited by the processing time allowed by the system. For example, near real time systems wherein the image enhancements must be performed as seamlessly as possible have limited processing time to allow for image enhancements. In such systems, the level of filtering at which enhancements are performed according to an embodiment, is a function of processing time.

In another embodiment, the image to have noise and/or aliasing attenuation performed could enter a system for noise reduction with details concerning the image to be enhanced known ahead of time. For example, if a cell phone system is configured to allow for sending photos, the size of the image to have aliasing and/or noise reduction performed will be known ahead of time. Further, the type and abilities and common problems of a given digital camera may be known ahead of time. The information regarding the type of noise reduction appropriate for different types of digital cameras can be stored and available via a table or the like for image processing modules 36 and 46. According to an embodiment, therefore, the level of filtering required for enhancement can be predetermined

The lower the resolution of the image to be processed, the greater the speed of enhancement processing. Thus, modules 36 and 46 can be further refined to construct a pyramid with additional levels and apply the techniques given above, for example, to four or more levels of a pyramid. For larger images, for example, images of 2048×1600 pixels, the increase in processing speed is increased for pyramids with at least three or four levels.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

I claim:

1. A method for reducing noise and/or aliasing from an image sampled in a plurality of spatial phases, the method comprising:
selecting at least two of the plurality of spatial phases; and
performing a difference calculation of the at least two spatial phases to determine a measure of one or more noise and/or aliasing components.

2. The method of claim 1 further comprising:
removing the measure of the one or more noise and/or aliasing components.

3. The method of claim 1 wherein the at least two of the plurality of spatial phases include:
a spatial phase of a first color channel; and
a spatial phase of a second color channel related to the first color channel by having at least some shared color spectrum frequencies.

4. The method of claim 1 wherein the image is represented by a plurality of basis functions.

5. The method of claim 4 wherein the basis functions are defined in at least a high frequency and a low frequency to generate one or more high frequency basis functions and one or more low frequency basis functions, the measure of the one or more noise and/or aliasing components determined via:
(1) performing the difference calculation of the image using the high frequency basis functions to obtain a high frequency measure; and
(2) performing the difference calculation of the image using the low frequency basis functions to obtain a low frequency measure.

6. The method of claim 4 wherein the basis functions are defined in a plurality of frequencies, the measure of the one or more noise and/or aliasing components determined via
performing the difference calculation using the basis functions at one or more of the plurality of frequencies in a pyramid of frequencies.

7. The method of claim 6 wherein the performing the difference calculation using the basis functions at one or more of the plurality of frequencies in a pyramid of frequencies includes:
determining a magnitude representative of the basis functions one or more of the plurality of frequencies.

8. The method of claim 6 wherein the performing the difference calculation using the basis functions at one or more of the plurality of frequencies in a pyramid of frequencies further comprises:
determining a signal to noise ratio; and
attenuating the noise and/or aliasing components based on the signal to noise ratio.

9. The method of claim 8 wherein the attenuating the noise and/or aliasing components based on the signal to noise ratio includes:
attenuating if the signal to noise ratio is approximately at least 1.0.

10. The method of claim 8 wherein the attenuating the noise and/or aliasing components based on the signal to noise ratio includes:
attenuating if the signal to noise ratio is at least a predetermined inflection point.

11. The method of claim 8 wherein the attenuating the noise and/or aliasing components based on the signal to noise ratio includes attenuating one or more of the plurality of basis functions representing the image.

12. The method of claim 11 wherein the attenuating one or more of the plurality of basis functions representing the image in frequency includes:
determining a channel represented by the one or more of the basis functions; and
using the measure of one or more noise and/or aliasing components to determine the attenuating the at least one noise component based on the signal to noise ratio for the channel.

13. The method of 12 wherein the channel is one of a I channel, a Q channel, and a Y channel.

14. The method of claim 13 wherein the measure of one or more noise and/or aliasing components for the I channel is determined via including one or more basis functions representing a red component and one or more basis functions representing a blue component.

15. The method of claim 13 wherein the correlated difference measure for the Y channel is determined via including one or more basis functions representing a first green component and a second green component.

16. The method of claim 13 wherein the correlated difference measure for the Q channel is determined including one or more basis functions representing a green-magenta component.

17. The method of claim 16 wherein the one or more basis functions representing the green-magenta component are altered via
determining a first magnitude of the measure of one or more noise and/or aliasing components between a first green component and a second green component;
determining a second magnitude related to red component and a blue component; and
attenuating the green-magenta component based on an average of the first magnitude and the second magnitude.

18. The method of claim 13 wherein the measure of one or more noise and/or aliasing components for the Y channel is determined via performing a difference calculation including one or more basis functions representing a red minus green component and a green minus blue component.

19. The method of claim 18 wherein the one or more basis functions representing the red minus green component and the green minus blue component are altered via
determining a magnitude of the measure of one or more noise and/or aliasing components for a first green component and a second green component, the first green component and the second green component limited to frequencies below a predetermined frequency; and
attenuating the red minus green component and the green minus blue component based on the magnitude.

20. A computer program product comprising a computer readable medium configured to perform one or more acts for removing noise and/or aliasing from an image created from an image sensor array, the one or more acts comprising:
one or more instructions for selecting at least two of the plurality of spatial phases; and
one or more instructions for performing a difference calculation of the at least two spatial phases to determine a measure of one or more noise and/or aliasing components.

21. The computer program product of claim 20 wherein the acts further comprise:
one or more instructions for removing the measure of the one or more noise and/or aliasing components.

22. The computer program product of claim 20 wherein the at least two of the plurality of spatial phases include:
a spatial phase of a first color channel; and
a spatial phase of a second color channel related to the first color channel by having at least some shared color spectrum frequencies.

23. The computer program product of claim 20 wherein the image is represented by a plurality of basis functions the plurality of basis functions representing the image in frequency.

24. The computer program product of claim 20 wherein the basis functions are defined in at least a high frequency and a low frequency to generate one or more high frequency basis functions and one or more low frequency basis functions, the measure of the one or more noise and/or aliasing components determined via:
(1) instructions for performing the difference calculation of the image using the high frequency basis functions to obtain a high frequency measure; and
(2) instructions for performing the difference calculation of the image using the low frequency basis functions to obtain a low frequency measure.

25. The computer program product of claim 23 wherein the basis functions are defined in a plurality of frequencies, the measure of the one or more noise and/or aliasing components determined via
one or more instructions for performing the difference calculation using the basis functions at one or more of the plurality of frequencies in a pyramid of frequencies.

26. The computer program product of claim 25 wherein the one or more instructions for performing the difference calculation using the basis functions at one or more of the plurality of frequencies in a pyramid of frequencies includes:
determining a magnitude representative of the basis functions one or more of the plurality of frequencies.

27. The computer program product of claim 25 wherein the one or more instructions for performing the difference calculation using the basis functions at one or more of the plurality of frequencies in a pyramid of frequencies further comprises:
one or more instructions for determining a signal to noise ratio; and
one or more instructions for attenuating the noise and/or aliasing components based on the signal to noise ratio.

28. A computer system comprising:
a processor;
a memory coupled to the processor;
an image processing module coupled to the memory, the image processing module configured to attenuate noise and/or aliasing from an image sampled in a plurality of spatial phases, module including:
a selection component configured to select at least two of the plurality of spatial phases; and
a measurement component configured to perform a difference calculation of the image at the at least two spatial phases to identify the noise and/or aliasing.

29. The computer system of claim 28 wherein the image processing module is disposed in a mobile device.

30. The computer system of claim 28 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.

31. The computer system of claim 28 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.

32. A mobile device comprising:
a processor; and
an image processing module coupled to the processor, the image processing module configured to attenuate noise and/or aliasing from an image sampled in a plurality of spatial phases, the image processing module including:
a selection component configured to select at least two of the plurality of spatial phases; and
a measurement component configured to perform a difference calculation of the image at the at least two spatial phases to identify the noise and/or aliasing.

33. The mobile device of claim 32 further comprising:
a digital camera coupled to the processor, the digital camera configured to collect the image in the plurality of spatial phases.

34. The mobile device of claim 32 wherein the mobile device is one or more of an electronic personal assistant a cellular/mobile phone, a pager and/or a mobile computing device.

35. The mobile device of claim 32 wherein the image processing module is configured to receive the image via one or more of a wire less local area network (WLAN), a cellular and/or mobile system, a global positioning system (GPS), a radio frequency system, an infrared system, an IEEE 802.11 system, and a wireless Bluetooth system.

36. A computer program product comprising a computer readable medium configured to perform one or more acts for attenuating noise and/or aliasing from an image created from an image sensor array, the one or more acts comprising:
one or more instructions for determining a first spatial phase difference between a first and a second color channel of an image created by the image sensor array having at least some shared color frequency data;
determining a second spatial phase difference between at least a third and fourth color channel of the image, the third and fourth color channels independent of the first and second color channels;
comparing a first magnitude of the first difference with a second magnitude of the second color difference; and
determining a noise and/or aliasing correction based on the comparing the first magnitude and the second magnitudes.

37. The computer program product of claim 36 further comprising:
if a difference between the first magnitude and the second magnitude is beyond a predetermined value, determining a color signal component.

38. The computer program product of claim 36 further comprising:
one or more instructions for applying a rectifying and smoothing filter to each of the first magnitude and the second magnitude, the rectifying and smoothing filter including:
one or more instructions for determining an absolute value of each pixel of an image; and
one or more instructions for low-pass filtering the absolute value with a filter width proportional to a wavelength, the low-pass filtering providing a magnitude of aliasing.

39. The computer program product of claim 36 wherein the noise and/or aliasing includes one or more of aliasing, artifacts and non-signal extraneous noise.

40. The computer program product of claim 36 wherein the acts further comprise:
one or more instructions for repeating the determining the first color difference, the determining the second color difference and the comparing the first magnitude with the second magnitude according to a pyramid structure of the image.

41. The computer program product of claim 40 wherein the acts are further comprising:
determining a gain to apply to each level of the pyramid structure of the image;
low-pass filtering the gain;
multiplying the low-pass filtered gain to provide a weighted low pass of the color that excludes aliased areas as determined by the gain.

42. The computer program product of claim 36 wherein the predetermined value is a function of a desired quality of an image.

43. The computer program product of claim 36 wherein image sensor array is a Bayer array.
